(19) United States
(12) Patent Application Publication
(10) Pub. No.: US 2026/0232113 A1
(43) Pub. Date: Aug. 13, 2026

(54) TELESCOPING CHAIR FOR ADDITIONAL MOBILITY IN VERTICAL DIRECTION

(71) Applicant: James Cocke, Valdosta, GA (US)

(72) Inventor: James Cocke, Valdosta, GA (US)

(21) Appl. No.: 19/438,122

(22) Filed: Dec. 31, 2025

Related U.S. Application Data
(60) Provisional application No. 63/833,667, filed on Dec. 31, 2024.

(51) Int. Cl. A47C 3/20

(52) U.S. Cl. CPC A47C 3/20

(57) ABSTRACT

A mobility chair includes a telescoping assembly that raises and lowers the chair to give a subject better access to low lying areas with the ability to return to a normal seated position as well.

### CROSS REFERENCE TO RELATED APPLICATIONS

This application is a nonprovisional of and claims priority to provisional patent application 63/833,667, filed Dec. 31, 2024.

### BACKGROUND

Individuals with disabilities often use chairs with wheels for horizontal mobility, but these kinds of chairs do not allow a person with a disability to lower themselves closer to the floor. People with disabilities often need access to items that are close to the floor, and they cannot reach the floor from normal chairs.

A need exists for a mobility chair that lowers an individual subject up and down for better access to low lying regions.

### SUMMARY

In one embodiment, an apparatus in the form of a chair may include an assembly for adjusting a seat. The apparatus may include an outermost casing configured to attach to the seat and an innermost casing operatively connected with the outermost casing, defining a telescoping assembly. An outer end of the outermost casing travels toward a respective outer end of the innermost casing and defines a range of motion for the telescoping assembly that extends between the outer end of the outermost casing to the respective outer end of the innermost casing. A support structure connected to the outer end of the innermost casing at proximal end of the support structure.

### BRIEF DESCRIPTION OF THE DRAWINGS

Features, aspects, and advantages of the present invention will become apparent from the following description and the accompanying exemplary embodiments shown in the drawings, which are briefly described below.

FIG. 1 is a perspective view of a mobility chair according to this disclosure.

FIG. 2 is a side view of a mobility chair according to this disclosure in an extended state.

FIG. 3 is a front elevation view of a mobility chair according to this disclosure in a compressed state.

FIG. 4 is an embodiment of a mobility chair according to this disclosure having a seat that reaches the floor between supporting arms of a wheel assembly.

### DETAILED DESCRIPTION

Terms in this disclosure are intended to have their broadest plain meaning as used context. The terms proximal and distal as used herein are relative to upper body and torso of the person in the mobility chair, with proximal aspects closest to the subject's torso and distal aspects closer to a floor on which the chair sits.

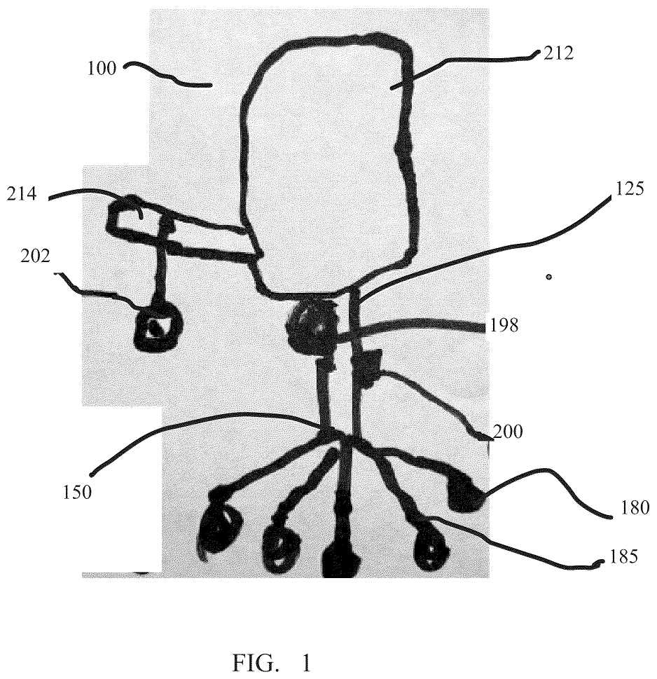

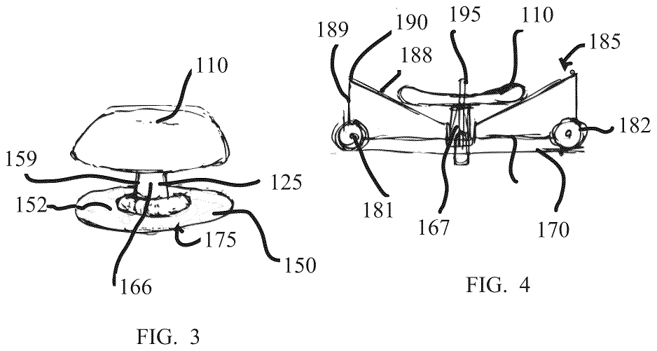

As shown in FIG. 1-4, an apparatus 100 has an assembly for adjusting a seat 110 and includes an outermost casing 115 configured to attach to the seat and an innermost casing 120 operatively connected with the outermost casing to define a telescoping assembly 125, wherein an outer end 130 of the outermost casing travels toward a respective outer end 135 of the innermost casing and defining a range of motion 140 for the telescoping assembly that extends between the outer end of the outermost casing to the respective outer end of the innermost casing. A support structure 150 is connected to the outer end of the innermost casing at proximal end 152 of the support structure.

The telescoping assembly defines a maximum height in an extended position 158, and the range of motion comprises a distance range 160 from the maximum height to the proximal end 152 of the support structure.

The telescoping assembly defines a minimum height 166 in a fully contracted position 159 that allows the seat to come within a defined distance 167 from the proximal end 152 of the support structure. The defined distance is so dimensioned to allow a subject sitting on the seat to place the subject's hands proximate to a floor 170 below the support structure. In non-limiting embodiments, the defined distance is 8 inches or less.

In non-limiting embodiments, the support structure further comprises a distal end 175 opposite the proximal end of the support structure, wherein the distal end connects to a wheel assembly 180 configured to impart a rolling function to the support structure. The wheel assembly comprises wheels 182 that roll on axles connected to supporting spokes 185 radiating from the support structure. The supporting spokes each comprise an elevated arm 188 connected to an axle attachment arm 189 connecting the wheels and axles to the supporting spokes. The elevated arm and the axle attachment arm define an angle 191 having a vertex 190 that is positioned above the proximate end of the support structure.

A separation distance 193 between the vertex and a longitudinal axis 195 of the telescoping assembly is so dimensioned to allow the seat to fit between the respective vertices of the supporting spokes.

The mobility chair may include a gear assembly 197 connected to the telescoping assembly and configured to extend and contract the telescoping assembly.

A motor 198 or a pneumatic actuator (not shown) or both may be used in actuating the gear assembly.

The chair may include a power source 200 connected to the motor and/or the pneumatic actuator for automatic actuation of the gear assembly to raise and lower the chair.

The gear assembly is controlled by a remote control 202 that provides signals to and receives return signals from the motor or the pneumatic actuator. The gear assembly may have a gear set housed within the support structure, wherein a driven gear is connected to a lead screw that raises and lowers the seat. Limit switches may be included in preventing over-extension and over-retraction of the telescoping assembly

In non-limiting embodiments, the electric motor is a motor with variable speed control allowing adjustment speeds between 0.5 and 2 inches per second.

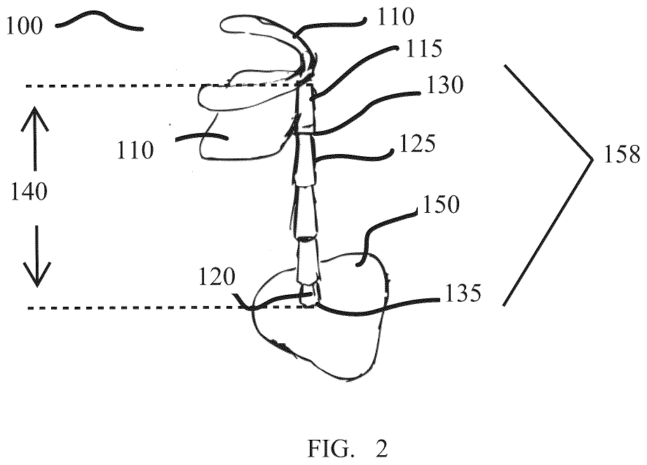

As shown in FIG. 2, the mobility chair may have a back support connected to the seat and configured to receive an individual's back and torso. Another option would be leg supports that fold to retract under the seat and unfold to extend outwardly from the seat. In this embodiment, the user can have support for outwardly extending legs and still have access to the floor as described herein.

Overall, the mobility chair provides a range of motion that is vertical relative to a substantially horizontal floor supporting the apparatus.

For purposes of this disclosure, the term “coupled” means the joining of two components (electrical, mechanical, or magnetic) directly or indirectly to one another. Such joining may be stationary in nature or movable in nature. Such joining may be achieved with the two components (electrical or mechanical) and any additional intermediate members being integrally defined as a single unitary body with one another or with the two components or the two components and any additional member being attached to one another. Such joining may he permanent in nature or alternatively may be removable or releasable in nature.

The present disclosure has been described with reference to example embodiments, however persons skilled in the art will recognize that changes may be made in form and detail without departing from the spirit and scope of the disclosed subject matter. For example, although different example embodiments may have been described as including one or more features providing one or more benefits, it is contemplated that the described features may he interchanged with one another or alternatively he combined with one another in the described example embodiments or in other alternative embodiments. Because the technology of the present disclosure is relatively complex, not all changes in the technology are foreseeable. The present disclosure described with reference to the exemplary embodiments is manifestly intended to be as broad as possible. For example, unless specifically otherwise noted, the exemplary embodiments reciting a single particular element also encompass a plurality of such particular elements.

Exemplary embodiments may include program products comprising computer or machine-readable media for carrying or having machine-executable instructions or data structures stored thereon. For example, the sensors and gears and remote control apparatuses may be computer driven. Exemplary embodiments illustrated in the methods of the figures may be controlled by program products comprising computer or machine-readable media for carrying or having machine-executable instructions or data structures stored thereon. Such computer or machine-readable media can be any available media which can be accessed by a general purpose or special purpose computer or other machine with a processor.

It is also important to note that the construction and arrangement of the elements of the system as shown in the preferred and other exemplary embodiments is illustrative only. Although only a certain number of embodiments have been described in detail in this disclosure, those skilled in the art who review this disclosure will readily appreciate that many modifications are possible (e.g., variations in sizes, dimensions, structures, shapes and proportions of the various elements, values of parameters, mounting arrangements, use of materials, colors, orientations, etc.) without materially departing from the novel teachings and advantages of the subject matter recited. For example, elements shown as integrally formed may be constructed of multiple parts or elements shown as multiple parts may be integrally formed, the operation of the assemblies may be reversed or otherwise varied, the length or width of the structures and/or members or connectors or other elements of the system may be varied, the nature or number of adjustment or attachment positions provided between the elements may be varied. It should be noted that the elements and/or assemblies of the system may be constructed from any of a wide variety of materials that provide sufficient strength or durability. Accordingly, all such modifications are intended to be included within the scope of the present disclosure. The order or sequence of any process or method steps may be varied or re-sequenced according to alternative embodiments. Other substitutions, modifications, changes and omissions may be made in the design, operating conditions and arrangement of the preferred and other exemplary embodiments without departing from the spirit of the present subject matter.

1. An apparatus with an assembly for adjusting a seat comprising:
an outermost casing configured to attach to the seat;
an innermost casing operatively connected with the outermost casing, defining a telescoping assembly, wherein an outer end of the outermost casing travels toward a respective outer end of the innermost casing and defining a range of motion for the telescoping assembly that extends between the outer end of the outermost casing to the respective outer end of the innermost casing;
a support structure connected to the outer end of the innermost casing at proximal end of the support structure.

2. The apparatus of claim 1, wherein the telescoping assembly defines a maximum height in an extended position, and the range of motion comprises a distance range from the maximum height to the proximal end of the support structure.

3. The apparatus of claim 1, wherein the telescoping assembly defines a minimum height 166 in a fully contracted position that allows the seat to come within a defined distance from the proximal end of the support structure.

4. The apparatus of claim 3, wherein the defined distance is so dimensioned to allow a subject sitting on the seat to place the subject's hands proximate to a floor below the support structure.

5. The apparatus of claim 3, wherein the defined distance is 8 inches or less.

6. The apparatus of claim 1, wherein the support structure further comprises a distal end opposite the proximal end of the support structure, wherein the distal end connects to a wheel assembly configured to impart a rolling function to the support structure.

7. The apparatus of claim 6, wherein the wheel assembly comprises wheels that roll on axles connected to supporting spokes radiating from the support structure.

8. The apparatus of claim 7, wherein the supporting spokes each comprise an elevated arm connected to an axle attachment arm connecting the wheels and axles to the supporting spokes.

9. The apparatus of claim 8, wherein the elevated arm and the axle attachment arm define an angle having a vertex that is positioned above the proximate end of the support structure.

10. The apparatus of claim 9, wherein a separation distance between the vertex and a longitudinal axis of the telescoping assembly is so dimensioned to allow the seat to fit between the respective vertices of the supporting spokes.

11. The apparatus of claim 1, further comprising a gear assembly connected to the telescoping assembly and configured to extend and contract the telescoping assembly.

12. The apparatus of claim 11, further comprising a motor or a pneumatic actuator or both actuating the gear assembly.

13. The apparatus of claim 12, further comprising a power source connected to the motor and/or the pneumatic actuator.

14. The apparatus of claim 12, wherein the gear assembly is controlled by a remote control 202 that provides signals to and receives return signals from the motor or the pneumatic actuator.

15. The apparatus of claim 14, wherein the gear assembly comprises a gear set housed within the support structure.

16. The apparatus of claim 15, wherein a driven gear is connected to a lead screw that raises and lowers the seat.

17. The apparatus of claim 16, further comprising limit switches preventing over-extension and over-retraction of the telescoping assembly.
